(19) United States
(12) Patent Application Publication
(10) Pub. No.: US 2009/0317664 A1
(43) Pub. Date: Dec. 24, 2009

(54) ELECTROCHEMICAL ENERGY SOURCE, AND METHOD FOR MANUFACTURING OF SUCH AN ELECTROCHEMICAL ENERGY SOURCE

(75) Inventors: Rogier Adrianus Henrica Niessen, Eindhoven (NL); Petrus Henricus Laurentius Notten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,372

(22) PCT Filed: Aug. 20, 2007
(86) PCT No.: PCT/IB07/53312

§ 371 Date: Feb. 23, 2009

(30) Foreign Application Priority Data
Aug. 22, 2006 (EP) 06119297.7

(51) Int. Cl. H01M 14/00; H01M 4/02; H01M 4/48; H01M 6/04; H01M 4/82

(52) U.S. Cl. 429/7; 429/209; 429/231.3; 429/224; 429/221; 429/231.2; 429/223; 429/231.5; 429/231.1; 429/207; 29/623.5

(57) ABSTRACT

An electrochemical energy source, comprising: a substrate, and at least one stack deposited onto said substrate, the stack comprising at least the active layers: an anode, a cathode, and an intermediate solid-state electrolyte separating said anode and said cathode. An electronic device provided with an electrochemical energy source according to the invention and a method for the manufacturing of an electrochemical source according to the invention.

### FIELD OF THE INVENTION

The invention relates to an electrochemical energy source, comprising: a substrate, and at least one stack deposited onto said substrate, the stack comprising at least the active layers: an anode, a cathode, and an intermediate solid-state electrolyte separating said anode and said cathode. The invention also relates to an electronic device provided with an electrochemical energy source according to the invention. The invention further relates to a method for the manufacturing of an electrochemical source according to the invention, comprising the step of: A) depositing at least one stack deposited onto a substrate, the stack comprising at least the following active layers: an anode, a cathode, and an intermediate solid-state electrolyte separating said anode and said cathode.

### BACKGROUND OF THE INVENTION

Electrochemical energy sources based on solid-state electrolytes are known in the art. These (planar) energy sources, or ‘solid-state batteries’, efficiently convert chemical energy into electrical energy and can be used as the power sources for portable electronics. At small scale such batteries can be used to supply electrical energy to e.g. microelectronic modules, more particular to integrated circuits (IC's). An example hereof is disclosed in the international patent application WO2005/027245, where a solid-state thin-film battery, in particular a lithium ion battery, is fabricated directly onto a structured silicon substrate provided with multiple slits or trenches in which an electron-conductive barrier layer, and a stack of a silicon anode, a solid-state electrolyte, and a cathode are deposited as active layers successively. The slits or trenches are provided in the substrate to increase the contact surface area between the different components of the stack to improve the rate capacity of the battery. The structured substrate may comprise one or more electronic components to form a so-called system-on-chip. The barrier layer is adapted to counteract diffusion of intercalating lithium into said substrate, which diffusion would result in a significant diminished storage capacity of the electrochemical source. Although the known battery exhibits commonly superior performance as compared to conventional solid-state batteries, the known battery has several drawbacks. It has been found that a major drawback of the known battery is that the active layers of the stack will commonly easily degrade due to an non-optimum choice of layer materials and/or the deposition order of the active layers of the stack. This degradation of one or more active layers may be manifested in that these active layers may decompose, may react with adjacent active layers to form interfacial layers with inferior properties and/or may (re)crystallize to form phases with unwanted properties.

It is an object of the invention to provide a relatively stable electrochemical energy source.

### SUMMARY OF THE INVENTION

This object can be achieved by providing an electrochemical energy source according to the preamble, characterized in that each active layer of the stack which is deposited prior to a subsequent active layer of the stack has a higher annealing temperature than the annealing temperature of the subsequent active layer. It has been found that the degradation of active layers in conventional energy sources known from the prior art, is often caused during deposition, in particular during annealing (also known as curing), of an active layer at a relatively high annealing temperature which may easily overheat, and consequently degrade adjacent active layers already deposited onto the substrate and annealed at a relatively low annealing temperature. This overheating of active layers of the stack deposited earlier may result in decomposition of these layers, allowing these layers to react with other adjacent layers to form detrimental interfacial layers with inferior properties, and/or allowing these layers to (re)crystallize to form phases with undesired properties. By gearing the annealing temperatures of the different active layers, and hence the active layers as such, into a successive order, degradation of these active layers can be prevented in a relatively efficient manner. According to the invention, the deposition order of the different active layers of the stack of the electrochemical energy source according to the invention is dictated by the order of the successive annealing temperatures, or temperature ranges, of the active layers to obtain a relatively stable electrochemical energy source having a relatively reliable performance, and which be manufactured in a relatively reliable manner. During manufacturing of the energy source according to the invention this means in general that the active layer deposited firstly can be deposited and/or annealed at any temperature (as long as the substrate allows it). The subsequent active layer of the stack shall be deposited/annealed at a temperature lower, and preferably significantly lower (about 50° C.), than the first active layer, and so on. This inherently means that the final active layer of the stack shall be deposited at the lowest temperature. Commonly, the annealing process is considered as being a (final) part of the deposition process of an active layer, wherein each active layer has its own optimum annealing temperature, or annealing temperature range, with which this active layer will acquire the specific material properties needed to function properly in the battery stack. Besides the critical deposition order which is applied to the electrochemical energy source according to the invention, preferably the materials of the different active layers are mutually chemically stable and compatible. A reaction between two chemically incompatible materials should preferably be avoided at any (annealing) temperature to secure a durable and adequate functioning of the electrochemical energy source according to the invention.

In a preferred embodiment the solid-state electrolyte is deposited on top of the cathode, and the anode is deposited on top of the solid-state electrolyte. According to this embodiment a stack is applied, wherein the cathode, the solid-state electrolyte, and the anode are deposited successively onto the substrate. The reason to apply this specific deposition order is that commonly the annealing temperature of the cathode is higher than the annealing temperature of the solid-state electrolyte which is thereupon higher than the annealing temperature of the anode. Although it is expected that commonly this deposition order will be applied in most electrochemical energy sources according to the invention, the invention is not limited to this specific deposition order. It could also be conceivable for a person skilled in the art to apply a reverse stack of an anode, on top of which an electrolyte is deposited, on top of which electrolyte a cathode is deposited. This reverse stack will probably be applied in case the annealing temperature of the anode is higher than the annealing temperature of the electrolyte which is thereupon higher than the annealing temperature of the cathode.

The electrochemical energy source preferably comprises at least two current collectors connected to the anode and to the cathode of the stack respectively. It is generally known to apply current collectors as electrode terminals. In case e.g. a Li-ion battery with a LiCoO₂ cathode is applied, preferably an aluminium current collector is connected to the LiCoO₂ cathode. Alternatively or in addition a current collector manufactured of, preferably doped, semiconductor such as e.g. Si, GaAs, InP, as of a metal such as silver, gold, platinum, copper or nickel may be applied as current collector in general with solid-state energy sources according to the invention. The current collectors are not part of the stack as defined above. Current collectors are commonly deposited at room temperature. Preferably a corrosion resistant current collector, such as a platinum current collector, is deposited onto the substrate, in case the first active layer of the stack is to be deposited in an oxygen environment at an annealing temperature (considerably) higher than room temperature. In case said first active layer is deposited in an inert environment, wherein practically no oxygen is present, at an increased annealing temperature the current collectors may be made of a material which is (significantly) less corrosion resistant, such as copper for example.

In a preferred embodiment of the energy source according to the invention the substrate and the anode are separated by means of an electron-conductive barrier layer adapted to at least substantially preclude diffusion of intercalating active species into said substrate. This preferred embodiment is commonly very advantageous, since intercalating reactive species taking part of the (re)charge cycles of the energy system according to the invention often diffuse into the substrate, such that these reactive species do no longer participate in the (re)charge cycles, resulting in a reduced storage capacity of the electrochemical source. Commonly, a monocrystalline silicon conductive substrate is applied to carry electronic components, such as integrated circuit, chips, displays, et cetera. This crystalline silicon substrate suffers from the drawback that the intercalating species diffuse relatively easily into said substrate, resulting in a reduced capacity of said energy source. For this reason it is considerably advantageous to apply a barrier layer onto said first substrate to preclude said unfavourable diffusion into the substrate. Migration of the intercalating species will be blocked at least substantially by said barrier layer, as a result of which migration of these species through the substrate will no longer occur. It is in particularly advantageous to apply a barrier layer in case the anode is connected to the substrate, wherein the anode is adapted for storage of active species in an atomic state. In lithium ion batteries commonly an (amorphous) silicon anode is deposited onto a (monocrystalline) silicon substrate, said silicon anode being adapted to store lithium species in an atomic state. To prevent a loss of effective active species preferably a barrier layer as defined above is applied to mutually separate the (silicon) anode and the (silicon) substrate. In case the anode is, however, not adapted to store active species in atomic state but rather in ionic state, commonly the application of a barrier layer is no longer required. An example of an anode which is adapted to store active species in ionic state is an oxygen containing anode. In this latter case, preferably a relatively corrosion resistant current collector, which may be made of platinum, is connected to the oxygen containing anode to counteract oxidation of the current collector during deposition of the anode layer. In case an electron-conductive barrier layer is applied this barrier layer may (also) be used to function as a current collector for the anode. In a preferred embodiment the barrier layer is preferably at least substantially made of at least one of the following compounds: tantalum (Ta), tantalum nitride (TaN), titanium (Ti), and titanium nitride (TiN). These compounds have as common property a relatively dense structure which is permeable for electrons and impermeable for the intercalating species, among which lithium (ions). The material of the barrier layer is however not limited to these compounds.

Preferably, the electrochemical energy source is formed by at least one battery selected from the group consisting of alkaline batteries and alkaline earth batteries. Alkaline (earth) storage batteries such as nickel-cadmium (NiCd), nickel-metal hydride (NiMH), or lithium-ion (Li-ion) storage batteries are commonly highly reliable, have a satisfying performance, and are capable of being miniaturized. For these advantages, they are used both as the power sources of portable appliances and industrial power sources, depending on their size. Preferably, the at least one electrode of the energy source, preferably formed by battery, is adapted for storage of ions of at least one of following elements: hydrogen (H), lithium (Li), beryllium (Be), magnesium (Mg), copper (Cu), silver (Ag), aluminium (Al), sodium (Na) and potassium (K), or any other suitable element which is assigned to group 1 or group 2 of the periodic table. So, the electrochemical energy source of the energy system according to the invention may be based on various intercalation mechanisms and is therefore suitable to form different kinds of batteries, e.g. Li-ion batteries, NiMH batteries, et cetera.

In a preferred embodiment the cathode is made of at least one material selected from the group consisting of: LiCoO₂ (600-800° C.) LiMn₂O₄ (˜600° C.), LiFePO₄ (˜700° C.), V₂O₅ (˜500° C.), MoO₃ (˜280° C.), WO₃ (˜300° C.), and LiNiO₂. It is has been found that at least these materials are highly suitable to be applied in lithium ion energy sources and, moreover, these materials have a predefined optimum annealing temperature range or temperature range (cited above in parentheses), based upon which an optimum deposition order may be determined. Examples of a cathode in case of a proton based energy source are Ni(OH)₂ and NiM(OH)₂, wherein M is formed by one or more elements selected from the group of e.g. Cd, Co, or Bi. It may be clear that also other cathode materials may be used in the electrochemical energy source according to the invention. The anode is preferably made of at least one material selected from the group consisting of: Si (<<600° C.), SnOₓ (˜350° C.), Li₄Ti₅O₁₂ (600-800° C.), SiOₓ, LiSiON, LiSnON, and LiSiSnON, in particular LiₓSiSn_{0.87}O_{1.20}N_{1.72}. As the cathode materials, these materials are suitable to be applied in a lithium ion battery, and, moreover, have a predefined optimum annealing temperature or temperature range (cited above in parentheses). The solid-state electrolyte is made of at least one material selected from the group consisting of: Li₅La₃Ta₂O₁₂ (Garnet-type class; 600-700° C.), LiPON (˜room temperature), LiNbO₃ (˜400° C.), LiTaO₃ (˜400° C.), and Li₉SiAlO₈ (˜900° C.), These solid-state electrolyte materials are suitable to be applied in lithium ion batteries, and have a known optimum annealing temperature (cited above in parentheses). Other solid-state electrolyte materials which may be applied smartly are lithium orthotungstate (Li₂WO₄), Lithium Germanium Oxynitride (LiGeON), Li₁₄ZnGe₄O₁₆ (lisicon), Li₃N, beta-aluminas, or Li_{1.3}Ti_{1.7}Al_{0.3}(PO₄)₃ (nasicon-type). A proton conducting electrolyte may for example be formed by TiO(OH), or ZrO₂Hₓ.

In a preferred embodiment the substrate is at least partially made of silicon. More preferably, a monocrystalline silicon conductive substrate is applied to carry electronic components, such as integrated circuit, chips, displays, et cetera. This crystalline silicon substrate suffers from this drawback that the intercalating active species diffuse relatively easily into said substrate, resulting in a reduced capacity of said energy source. For this reason it is considerably advantageous to apply a barrier layer onto said substrate to preclude said unfavourable diffusion into the substrate.

The invention also relates to an electronic device provided with at least one electrochemical energy source according to the invention. An example of such an electric device is a shaver, wherein the electrochemical energy source may function for example as backup (or primary) power source. Other applications which can be enhanced by providing a backup power supply comprising an energy system according to the invention are for example portable RF modules (like e.g. cell phones, radio modules, et cetera), sensors and actuators in (autonomous) micro systems, energy and light management systems, but also digital signal processors and autonomous devices for ambient intelligence. It may be clear this enumeration may certainly not being considered as being limitative. Another example of an electric device wherein an energy source according to the invention may be incorporated (or vice versa) is a so-called ‘system-in-package’ (SiP). In a system-in-package one or multiple electronic components and/or devices, such as integrated circuits (ICs), chips, displays, et cetera, are embeddded at least partially in the substrate, in particuarly a monocrystalline silicon conductive substrate, of the electrochemical energy source according to the invention.

The invention further relates to a method according to the preamble, characterized in that during step A) the active layers of stack are deposited in a deposition order wherein an subsequent active layer of the stack which is deposited onto a prior active layer of the stack has a lower annealing temperature than the annealing temperature of said prior active layer of the stack. Advantages of this method have already been elucidated above in a comprehensive manner. Preferably, during step A) the cathode, the solid-state electrolyte, and the anode are deposited successively onto the substrate. Commonly this deposition order will be in harmony with a decrease in an optimum annealing temperature for the active layers of the stack respectively. In a preferred embodiment the method further comprises step B) of depositing a first current collector onto the substrate prior to step A), on top of which current collector the stack is deposited during step A). In another preferred embodiment the method further comprises step C) of depositing a second current collector onto the stack deposited onto the substrate during step A). Particular examples of materials of active layers of the stack, and of the current collector(s) to be applied have already been elucidated above.

### BRIEF DESCRIPTION OF THE DRAWINGS

The invention is illustrated by way of the following non-limitative examples, wherein:

FIG. 1 shows a schematic cross section of an electrochemical energy source according to the prior art, and

FIG. 2 shows a schematic cross section of an electrochemical energy source according to the invention.

### DETAILED DESCRIPTION OF THE EMBODIMENTS

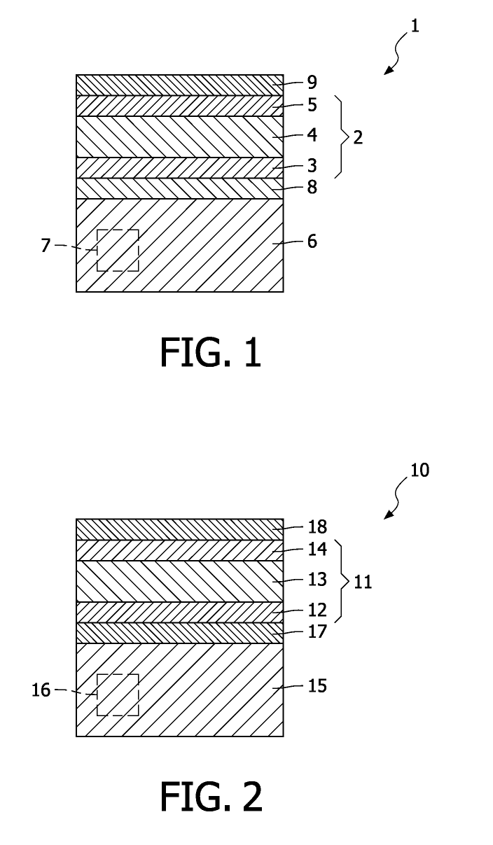

FIG. 1 shows a schematic cross section of an electrochemical energy source 1 known from the prior art. An example of the electrochemical energy source 1 shown in FIG. 1 is also disclosed in the international patent application WO2005/027245. The known energy source 1 comprises a lithium ion battery stack 2 of an anode 3, a solid-state electrolyte 4, and a cathode 5, which battery stack 2 is deposited onto a conductive substrate 6 in which one or more electronic components 7 are embedded. In this example the substrate 6 is made of doped silicon, while the anode 3 is made of amorphous silicon (a-Si). The cathode 5 is made of LiCoO₂, and the solid-state electrolyte is made of LiNbO₃. Between the battery stack 2 and the substrate 6 a lithium barrier layer 8 is deposited onto the substrate 6. In this example, the lithium diffusion barrier layer 8 is made of tantalum. The conductive tantalum layer 8 acts as a chemical barrier, since this layer counteracts diffusion of lithium ions (or other active species) initially contained by the stack 2 into the substrate 6. In case lithium ions would leave the stack 2 and would enter the substrate 6 the performance of the stack 2 would be affected. Moreover, this diffusion would seriously affect the electronic component(s) 7 embedded within the substrate 6. In this example, the lithium diffusion barrier layer 8 also acts as a current collector for the anode 3 in the known electrochemical energy source 1. The energy source 1 further comprises an additional current collector 9 made of aluminium which is deposited on top of the battery stack 2, and in particularly on top of the cathode 5. Deposition of the individual layers 3, 4, 5, 8, 9 can be achieved, for example, by means of CVD, sputtering, E-beam deposition or sol-gel deposition. Deposition of the different active layers 3, 4, 5 of the stack 2 in the deposition order as shown in FIG. 1 may likely yield problems, which are detrimental for the performance of the energy source 1 both in short term and in long term. These problems to be expected can be deduced from the following table (Table 1) in which more details are given regarding the materials, especially the required phases and optimum annealing temperatures needed to obtain these preferred phases for each individual material.

TABLE 1

| Depo- | | | | Optimum |
|---|---|---|---|---|
| sition | | | Preferred | annealing |
| order | Type | Material | phase | temperature |
| 1 | barrier and | Ta | — | ~room temperature |
| | current collector | | | |
| 2 | anode | a-Si | amorphous | <<600° C. |
| 3 | solid electrolyte | LiNbO₃ | amorphous | <450° C. |
| 4 | cathode | LiCoO₂ | HT- | >>600° C. |
| | | | crystalline | preferably 800° C. |
| | | | rombohedral | |
| 5 | current collector | Al | — | ~room temperature |

Considering the entire deposition of the different active layers 3, 4, 5, 8, 9 and in particular the active layers 3, 4, 5 of battery stack 2 again, including the data given in Table 1, several possible problems due to a non-optimum deposition order are expected to occur. The deposition of the first layer 1, id est the barrier layer 8, onto the substrate 6 at room temperature using Atomic Layer Deposition (ALD) will be readily feasible, as well as the deposition of the silicon anode 3 (substantially) below 600° C., preferably at a few hundred degrees Celsius. Deposition of the solid-state electrolyte 4 made of LiNbO₃ at temperatures below 450° C. will yield amorphous material as required. However, deposition of LiNbO₃ will require an oxygen atmosphere and temperatures around 200° C. in order to decompose metal-organic precursors used during deposition. This can result in the formation of SiCO₂ at the Si/LiNbO₃ interface of the anode 3 and the electrolyte 4, which is unwanted as SiCO₂ will probably act as a blocking layer.

Subsequent deposition of LiCoO₂ to form the cathode 5 at temperatures below 600° C. will yield merely amorphous material, which is electrochemically inferior to the preferred HT crystalline phase. However, post annealing at 800° C., in order to crystallize the cathode 5 will cause additional phenomena in the underlying and already deposited layers; the LiNbO₃ electrolyte 4 has a crystallization temperature of about 470° C., and will hence crystallize at this relatively high annealing temperature, resulting in inferior Li-ion conducting properties. The amorphous Si of the anode 3 crystallizes to polycrystalline Si, which is not detrimental to the Li-intercalating behave of the anode 3. Hugely increasing the annealing temperature of the cathode 5 will result in severe intermixing at the Si/LiNbO₃ interface of the anode 3 and the electrolyte 4 as both are not chemically stable. The deposition of the last layer, the cathode current collector 9, can be done under relatively mild conditions once again at room temperature and no problems are expected during this deposition step. The above shows that deposition of the active layers 3, 4, 5 of the battery stack 2 is not straight-forward and might yield potential bottlenecks.

FIG. 2 shows a schematic cross section of an electrochemical energy source 10 according to the invention. The electrochemical energy source 10 differs from the electrochemical energy source 1 as shown in FIG. 1 in that the energy source 10 shown in FIG. 2 is characterized by a consistent and smart choice of materials of and subsequent smart deposition order of the different materials as will be elucidated hereinafter. The electrochemical energy source 10 according to the invention comprises a lithium ion battery stack 11 of an cathode 12, a solid-state electrolyte 13, and a anode 14, which battery stack 11 is deposited onto a conductive substrate 15 in which one or more electronic components 16 are embedded. In this example the substrate 15 is made of doped silicon, the cathode 12 is made of LiCoO₂, the electrolyte 13 is made of Li₅La₃Ta₂O₁₂, and the anode 14 is made of amorphous silicon (a-Si). Between the battery stack 11 and the substrate 15 a cathode current collector 17 made of platinum is deposited. On top of the anode 14 an anode current collector 18 is deposited. The anode current collector 18 is made of tantalum in this example, as a result of which conductive tantalum layer 18 may also act as a chemical barrier to preclude diffusion of active species into the substrate 15 in case the anode 14 is brought in (direct) connection with the substrate 15. Deposition of the individual layers 12, 13, 14, 17, 18 can be realized again by means of e.g. CVD, sputtering, E-beam deposition or sol-gel deposition. As will be clear the material choice of particular layers 13, 17 has been modified with respect to corresponding layers 4, 9 of the energy source 1 shown in FIG. 1. Moreover, it will be clear the stack 11 has been deposited in reverse order with respect to the deposition order of the stack 2 as shown in FIG. 1. The improved deposition order can be elucidated by means of the relevant material data given in table 2.

TABLE 2

| Depo- | | | | Optimum |
|---|---|---|---|---|
| sition | | | Preferred | annealing |
| order | Type | Material | phase | temperature |
| 1 | cathode current | Pt | — | ~RT |
| | collector | | | |
| 2 | cathode | LiCoO₂ | HT- | >>600° C. |
| | | | crystalline | pref. 800° C. |
| | | | rombohedral | |
| 3 | solid electrolyte | Li₅La₃Ta₂O₁₂ | Garnet-type | 600-700° C. |
| 4 | anode | a-Si | amorphous | <<600° C. |
| 5 | current collector | Ta | — | ~RT |

Considering this improved deposition order, it can be seen that the optimum annealing temperature to obtain an active material layer 12, 13, 14 of the stack 11 in the preferred phase is lower for each subsequent active layer 13, 14 than the optimum annealing temperature for each active layer 12, 13 deposited earlier than the subsequent layers 13, 14 of the stack 11. During manufacturing of the electrochemical energy source 10 as shown in FIG. 2, the deposition of the platinum layer 17 will be readily feasible. The deposition of the LiCoO₂ to form the cathode 12 at an optimum annealing temperature (>>600° C., preferably about 800° C.) will yield the preferred rombohedral phase. As platinum is highly resistant against corrosion, even at temperatures of 600-800° C. in an oxygen environment, no interfacial (blocking) oxide layers will be formed between the Pt and LiCoO₂. Subsequent deposition of the Garnet-type solid electrolyte 13 utilizing appropriate metal-organic precursors (preferably Li, La, and Ta) can be realised at reduced temperature (600-700° C.) in an oxygen atmosphere. Studies that have been performed show that the Garnet-type electrolyte 13 and LiCoO₂ based cathode 12 are chemically compatible with each other. The deposition of a-Si to form the anode 14 can be readily done at mild temperatures of a few hundred degrees Celsius. The deposition of the anode current collector 18 made of tantalum can be realised at or near room temperature again. It is clear that if a revised deposition order is chosen, and care is taken that the materials are chemically stable versus each other, a complete battery stack 11 can be deposited without any obvious interface phenomena or decomposition. It is noted that the materials opted for in the shown example, in particular as listed in Table 2, can be readily replace by other materials, as long as the requirements stated above are met.

It should further be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Electrochemical energy source, comprising:
a substrate, and
at least one stack deposited onto said substrate, the stack comprising at least the active layers:
an anode,
a cathode, and
an intermediate solid-state electrolyte separating said anode and said cathode, characterized in that each active layer of the stack which is deposited prior to a subsequent active layer of the stack has a higher annealing temperature than the annealing temperature of the subsequent active layer.

2. Electrochemical energy source according to claim 1, characterized in that the solid-state electrolyte is deposited on top of the cathode, and that the anode is deposited on top of the solid-state electrolyte.

3. Electrochemical energy source according to claim 1, characterized in that the electrochemical energy source comprises at least two current collectors connected to the anode and to the cathode of the stack respectively.

4. Electrochemical energy source according to claim 1, characterized in that the electrochemical energy source comprises at least one electron-conductive barrier layer being deposited between the substrate and the anode, which barrier layer is adapted to at least substantially preclude diffusion of active species of the stack into said substrate.

5. Electrochemical energy source according to claim 4, characterized in that the at least one barrier layer is made of at least one of the following materials: tantalum, tantalum nitride, titanium, and titanium nitride.

6. Electrochemical energy source according to claim 3, characterized in that at least one current collector is made of at least one of the following materials: aluminium, gold, silver, platinum, copper, and nickel.

7. Electrochemical energy source according to claim 1, characterized in that at least one of the anode and the cathode is adapted for storage of ions of at least one element selected from the group consisting of: H, Li, Be, Mg, Cu, Ag, Al, Na and K.

8. Electrochemical energy source according to claim 1, characterized in that the cathode is made of at least one material selected from the group consisting of: LiCoO2, LiMn2O4, LiFePO4, V2O5, LiNiO2, MoO3, and WO3.

9. Electrochemical energy source according to claim 1, characterized in that the anode is made of at least one material selected from the group consisting of: Si, SiOx, SnOx, Li4Ti5O12, LiSiON, LiSnON, and LiSiSnON.

10. Electrochemical energy source according to claim 1, characterized in that the solid-state electrolyte is made of at least one material selected from the group consisting of: Li5La3Ta2O12, LiPON, LiNbO3, LiTaO3, Li9SiAlO8, Li2WO4, LiGeON, Li14ZnGe4O16 (lisicon), Li3N, beta-aluminas, Li1.3Ti1.7Al0.3(PO4)3 (nasicon-type), TiO(OH), and ZrO2Hx.

11. Electrochemical energy source according to claim 1, characterized in that the substrate comprises Si.

12. Electronic device provided with at least one electrochemical energy source of claim 1.

13. Electronic device according to claim 12, characterized in that the at least one electronic component, in particular an integrated circuit (IC), is at least partially embedded in the substrate of the electrochemical energy source.

14. Electronic device according to claim 12, characterized in that the electronic device and the electrochemical energy source form a System in Package (SiP).

15. Method for manufacturing of an electrochemical energy source according to claim 1, comprising the step of:
A) depositing at least one stack deposited onto a substrate, the stack comprising at least the following active layers:
an anode,
a cathode, and
an intermediate solid-state electrolyte separating said anode and said cathode,
characterized in that during step A) the active layers of stack are deposited in a deposition order wherein an subsequent active layer of the stack which is deposited onto a prior active layer of the stack has a lower annealing temperature than the annealing temperature of said prior active layer of the stack.

16. Method according to claim 15, characterized in that during step A) the cathode, the solid-state electrolyte, and the anode are deposited successively onto the substrate.

17. Method according to claim 15, characterized that the method further comprises step B) of depositing a first current collector onto the substrate prior to step A), on top of which current collector the stack is deposited during step A).

18. Method according to claim 15, characterized in that the method further comprises step C) of depositing a second current collector onto the stack deposited onto the substrate during step A).
